(19) United States
(12) Patent Application Publication
(10) Pub. No.: US 2022/0136478 A1
(43) Pub. Date: May 5, 2022

(54) INTERNAL-COMBUSTION-ENGINE COMBUSTION STATE CONTROL APPARATUS

(71) Applicant: Mitsubishi Electric Corporation, Tokyo (JP)

(72) Inventor: Takahiko INADA, Tokyo (JP)

(73) Assignee: Mitsubishi Electric Corporation, Tokyo (JP)

(21) Appl. No.: 17/203,914

(22) Filed: Mar. 17, 2021

(30) Foreign Application Priority Data
Nov. 4, 2020 (JP) 2020-184104

(51) Int. Cl. F02P 5/15; F02P 9/00

(52) U.S. Cl. CPC F02P 5/15; F02P 9/002

(57) ABSTRACT

The internal-combustion-engine combustion state control apparatus includes an ignition control means that generates two or more ignition signals during a single compression stroke or a single combustion stroke of an internal combustion engine, a high voltage means that makes an ignition plug, provided in a combustion chamber of the internal combustion engine, perform an ignition discharge based on the ignition signal, an ignition-discharge parameter detection circuit that detects a parameter indicating a state of the ignition discharge, an ignition-discharge duration detection means that detects two or more ignition discharge durations, based on an output signal of the ignition-discharge parameter detection circuit, and an abnormal-combustion determination means that diagnoses a combustion state of the internal combustion engine, based on at least one of the two or more ignition discharge durations; an abnormal-combustion-suppression control means is made to operate based on the result of a determination by the abnormal-combustion determination means.

### BACKGROUND OF THE INVENTION

### Field of the Invention

The present disclosure relates to an internal-combustion-engine combustion state control apparatus.

### Description of the Related Art

In recent years, the problems such as environment preservation and fuel depletion have been raised; measures for these problems have become big issues also in the automobile industry. As the measures therefor, many technologies for raising the efficiency of an engine to the maximum have been developed. However, on the other hand, the occurrence frequency of abnormal combustion has become high, and hence damage to the engine, deterioration of the durability thereof, deterioration of the marketability thereof, and the like have become matters of concern. Accordingly, it is required that in order to prevent abnormal combustion, the combustion state of an internal combustion engine is adequately controlled.

To date, as an apparatus for detecting abnormal combustion of an internal combustion engine, there has been proposed an internal-combustion-engine control apparatus having a combustion-state determination unit in which in the case where the ignition discharge duration of an internal combustion engine, i.e., the spark discharge duration thereof is shorter than a predetermined value, it is determined that abnormal combustion has occurred (for example, refer to Patent Document 1).

### PRIOR ART REFERENCE

### Patent Literature

[Patent Document 1] Japanese Patent Application Laid-Open No. 2016-56684

Abnormal combustion of an internal combustion engine occurs at a time when a fuel-air mixture is compressed in a cylinder of the internal combustion engine so as to have a high temperature and then the high-temperature state continues for a long time. The pressure in the cylinder becomes high during a time between a time point when the piston is at the compression bottom dead center and a time point when the piston is at the compression top dead center, and the temperature of the fuel-air mixture becomes high in accordance with the inner-cylinder pressure. Then, before the compression top dead center, a cold-flame reaction progresses from a specific temperature correlated with the inner-cylinder pressure, and then the high-temperature state continues for a long time; as a result, abnormal combustion occurs. For example, in the case of regular gasoline, a cold-flame reaction starts from approximately 500° C. Although it differs depending on the inner-cylinder temperature condition, it has experimentally been confirmed that there occurs a delay of the occurrence of abnormal combustion after the start of a cold-flame reaction and, due to the delay, the timing at which the abnormal combustion occurs may be after the timing of the compression top dead center or after the ignition timing.

In the conventional apparatus disclosed in Patent Document, there has been a following problem: when during an ignition discharge, abnormal combustion starts, the pressure and the temperature in the gap between the electrodes of an ignition plug drastically increases and hence the ignition discharge duration is shortened; however, in the case where the ignition timing is set at a more advanced angle side in the rotation direction of the crankshaft than the foregoing timing at which abnormal combustion occurs is, the pressure and the temperature do not drastically increase during an ignition discharge and hence no abnormal combustion can be detected during the ignition discharge duration.

The present disclosure discloses a technology for solving such a problem as described above; the objective thereof is to provide an internal-combustion-engine combustion state control apparatus that realizes high-accuracy detection of abnormal combustion.

### SUMMARY OF THE INVENTION

An internal-combustion-engine combustion state control apparatus disclosed in the present disclosure is characterized by including

an ignition control means that generates two or more ignition signals during a single compression stroke or a single combustion stroke of an internal combustion engine,

an ignition apparatus including a high voltage means that makes an ignition plug, provided in a combustion chamber of the internal combustion engine, generate an ignition discharge based on the ignition signal, and an ignition-discharge parameter detection circuit that detects a parameter indicating a state of the ignition discharge,

an ignition-discharge duration detection means that detects two or more ignition discharge durations, which are respective durations of the two or more ignition discharges generated during a single compression stroke or a single combustion stroke of the internal combustion engine based on an output signal of the ignition-discharge parameter detection circuit,

an abnormal-combustion determination means that diagnoses whether or not abnormal combustion has occurred in the internal combustion engine, based on at least one of the detected two or more ignition discharge durations, and

an abnormal-combustion-suppression control means that controls the internal combustion engine so as to suppress the abnormal combustion, when the abnormal-combustion determination means diagnoses that the abnormal combustion has occurred.

The present disclosure makes it possible to obtain an internal-combustion-engine combustion state control apparatus that realizes high-accuracy detection of abnormal combustion.

The foregoing and other object, features, aspects, and advantages of the present invention will become more apparent from the following detailed description of the present invention when taken in conjunction with the accompanying drawings.

### BRIEF DESCRIPTION OF THE DRAWINGS

FIG. 1 is a view schematically illustrating the configuration of an internal combustion engine;

FIG. 2 is a block diagram representing the configuration of an internal-combustion-engine combustion state control apparatus according to Embodiment 1;

FIG. 3 is a circuit diagram representing an example of an ignition apparatus in the internal-combustion-engine combustion state control apparatus according to Embodiment 1;

FIG. 4A is a timing chart representing the operation of the internal-combustion-engine combustion state control apparatus according to Embodiment 1 at a time when relatively strong abnormal combustion has occurred;

FIG. 4B is a timing chart representing the operation of the internal-combustion-engine combustion state control apparatus according to Embodiment 1 at a time when relatively weak abnormal combustion has occurred;

FIG. 4C is a timing chart representing the operation of the internal-combustion-engine combustion state control apparatus according to Embodiment 1 at a time when no abnormal combustion has occurred;

FIG. 5A is a flowchart representing the operation of the internal-combustion-engine combustion state control apparatus according to Embodiment 1;

FIG. 5B is a flowchart representing the operation of an abnormal-combustion-determination execution decision in the internal-combustion-engine combustion state control apparatus according to Embodiment 1;

FIG. 6 is a timing chart representing the operation of an internal-combustion-engine combustion state control apparatus according to Embodiment 3;

FIG. 7 is a circuit diagram representing an example of an ignition apparatus in an internal-combustion-engine combustion state control apparatus according to Embodiment 4; and

FIG. 8 is a circuit diagram representing an example of an ignition apparatus in an internal-combustion-engine combustion state control apparatus according to Embodiment 5.

### DETAILED DESCRIPTION OF THE PREFERRED EMBODIMENTS

### Embodiment 1

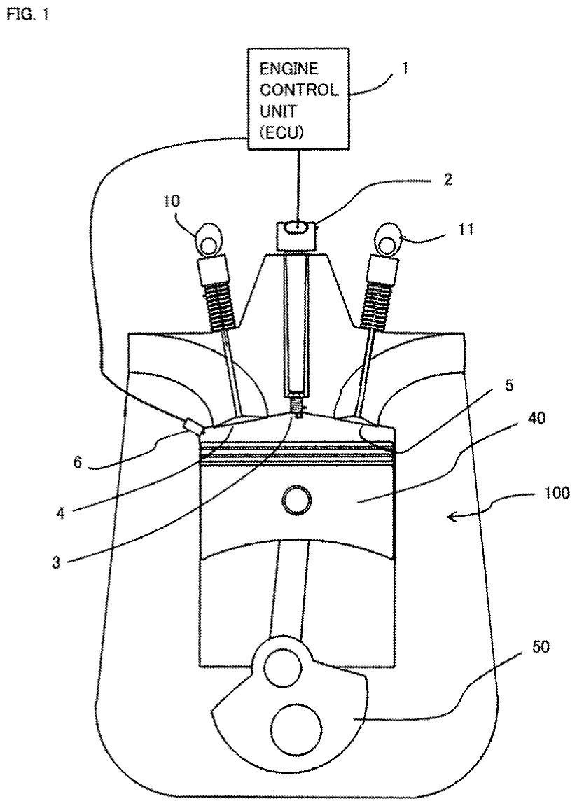

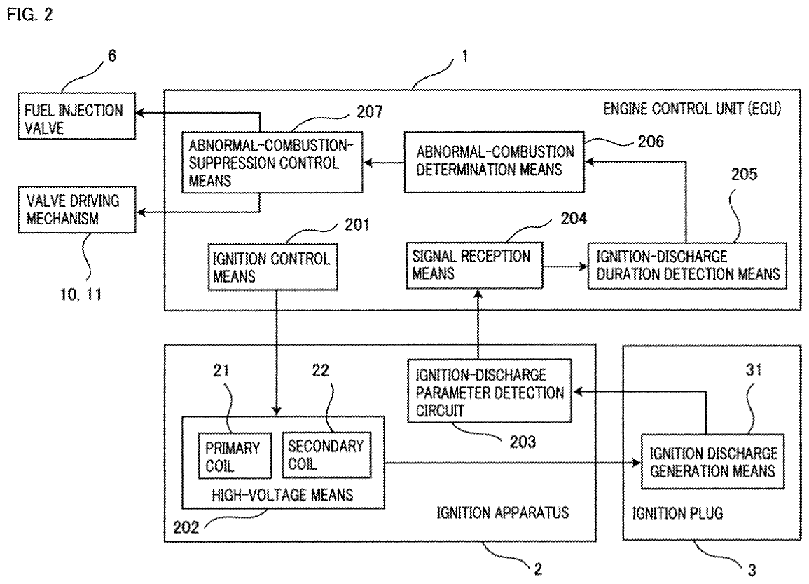

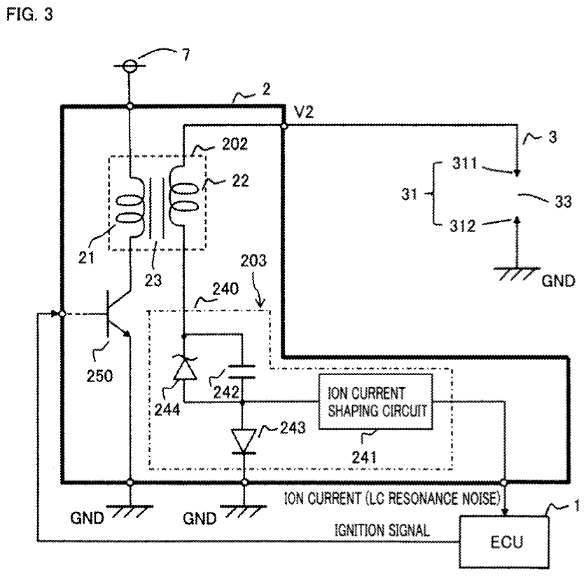

Hereinafter, an internal-combustion-engine combustion state control apparatus according to Embodiment 1 will be explained based on drawings. FIG. 1 is a view schematically illustrating the configuration of an internal combustion engine; FIG. 2 is a block diagram representing an internal-combustion-engine combustion state control apparatus according to Embodiment 1; FIG. 3 is a circuit diagram representing an example of an ignition apparatus in the internal-combustion-engine combustion state control apparatus according to Embodiment 1. In each of FIGS. 1 through 3, an ignition plug 3 connected with an ignition apparatus 2 is provided on the top of a cylinder 100 of an internal combustion engine. A piston 40 coupled with a crankshaft 50 is contained in the cylinder 100 of the internal combustion engine. A fuel injection valve 6 for injecting a fuel into a combustion chamber is provided in the cylinder 100 of the internal combustion engine.

The cylinder 100 of the internal combustion engine is provided with an intake valve 4, an exhaust valve 5, and a valve driving mechanism 10 for driving the intake valve 4, and a valve driving mechanism 11 for driving the exhaust valve 5. The intake valve 4 is driven by the valve driving mechanism 10 so as to open or close, and the exhaust valve 5 is driven by the valve driving mechanism 11 so as to open or close. The valve driving mechanisms 10 and 11 are coupled with an unillustrated phase changing system in such a way that the respective opening/closing timings of the intake valve 4 and the exhaust valve 5 can be changed by the phase changing system.

The ignition plug 3 is provided with a first electrode 311, as a central electrode to which an ignition voltage for executing a spark discharge is applied, and a second electrode 312 that faces the first electrode 311 via a gap 33 and is connected with a ground potential portion GND; when the foregoing ignition voltage is applied to the gap between the first electrode 311 and the second electrode 312, a spark discharge occurs in the gap 33; then, an inflammable fuel-air mixture inside the combustion chamber of the cylinder 100 is ignited or catches fire (referred to simply as “ignition”, hereinafter) and combusts. The first electrode 311 and the second electrode 312 of the ignition plug 3 is included in an ignition discharge generation means 31.

The ignition apparatus 2 is mechanically and integrally fixed to the ignition plug 3 and is provided with a primary coil 21 connected with a battery (unillustrated) or a power source 7 supplied with electric power by a battery, a secondary coil 22 magnetically coupled with the primary coil 21 through a magnetic iron core 23, and an ignition-discharge parameter detection circuit 203. As represented in FIG. 3, in Embodiment 1, the ignition-discharge parameter detection circuit 203 is provided with an ion current detection circuit 240. A transistor 250 connected between the primary coil 21 and the ground potential portion GND is on/off-controlled, as described later, by an ignition signal from an engine control unit (hereinafter, referred to as an ECU) 1 so as to control supply and cutoff of a primary current that flows in the primary coil 21. In Embodiment 1, a high voltage means 202 includes the primary coil 21, the secondary coil 22, and the magnetic iron core 23.

As represented in FIG. 3, the ion current detection circuit 240 provided in the ignition-discharge parameter detection circuit 203 includes a capacitor 242 connected with the low-voltage side of the secondary coil 22 of the ignition apparatus 2, a diode 243 inserted between the capacitor 242 and the ground potential portion GND of the ignition coil device 2, and a voltage-limiting Zener diode 244 connected in parallel with the capacitor 242. The capacitor 242 and the diode 243 form a bias circuit for the secondary coil 22.

The capacitor 242 and the Zener diode 244 connected in parallel with the capacitor 242 are connected with the low-voltage side of the secondary coil 22 and with the ground potential portion GND via diode 243 and form a charging path for charging the capacitor 242 with a bias voltage when an ignition discharge current is generated. The foregoing bias voltage functions as a power source for detecting an ion current; an ion-current shaping circuit 241 applies multiplication processing or the like to the detected ion current.

ECU 1 obtains the output of the ignition-discharge parameter detection circuit 203 through a signal reception means 204. In the present Embodiment, the output of the ignition-discharge parameter detection circuit 203 corresponds to the output of the ion-current shaping circuit 241. The signal reception means 204 converts a current signal into a voltage signal and then converts the voltage signal into a signal to be processed by a microcomputer, through an A/D converter. The details thereof will be described later; however, because the output of the ignition-discharge parameter detection circuit 203 is a high-frequency signal, it is desirable that the sampling rate of the A/D conversion is set to a high-speed rate (approximately several [μs] to several tens [μs]).

ECU 1 applies processing predetermined by an ignition-discharge duration detection means 205 to the signal obtained by the signal reception means 204 so as to obtain an ignition discharge duration. In addition, in accordance with the operation condition of the internal combustion engine, ECU 1 makes an ignition control means 201 generate two or more ignition signals during a single compression stroke or a single combustion stroke. Moreover, ECU 1 makes an abnormal-combustion determination means 206 determine whether or not abnormal combustion has occurred, based on the ignition discharge duration obtained from the ignition-discharge duration detection means 205. Furthermore, in the case where the abnormal-combustion determination means 206 determines that abnormal combustion has occurred, ECU 1 makes an abnormal-combustion-suppression control means 207 control any one of the fuel injection valve 6 and the valve driving mechanisms 10 and 11, or both of the fuel injection valve 6 and the valve driving mechanisms 10 and 11, so that the internal combustion engine is controlled so as to suppress the abnormal combustion.

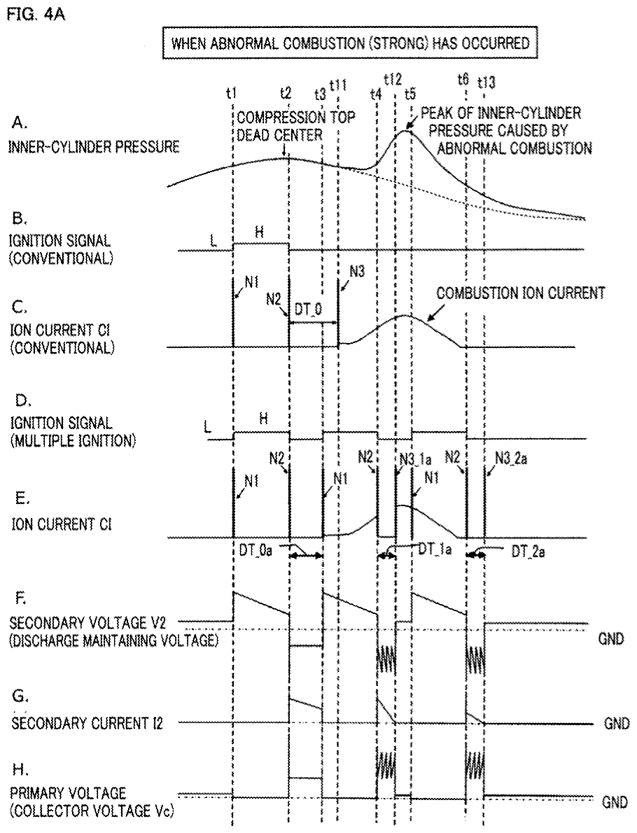

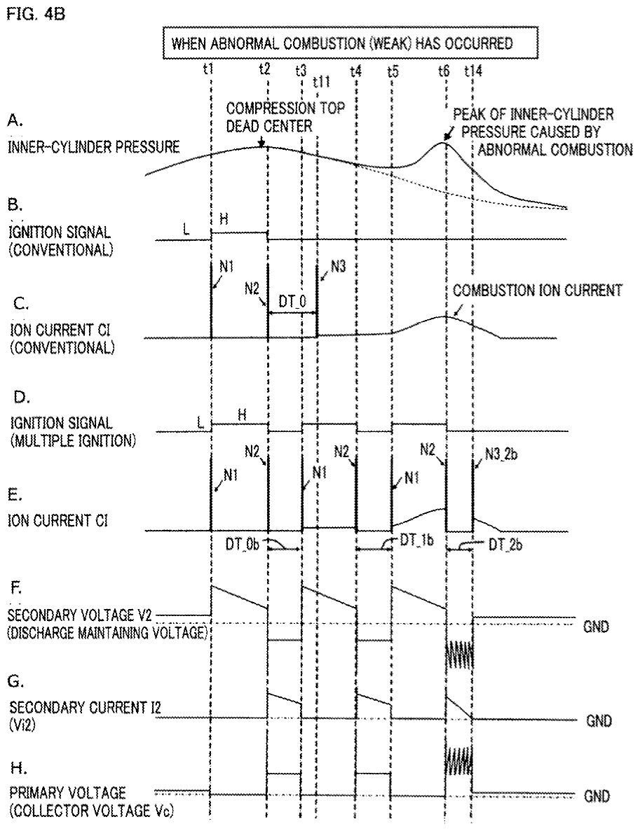

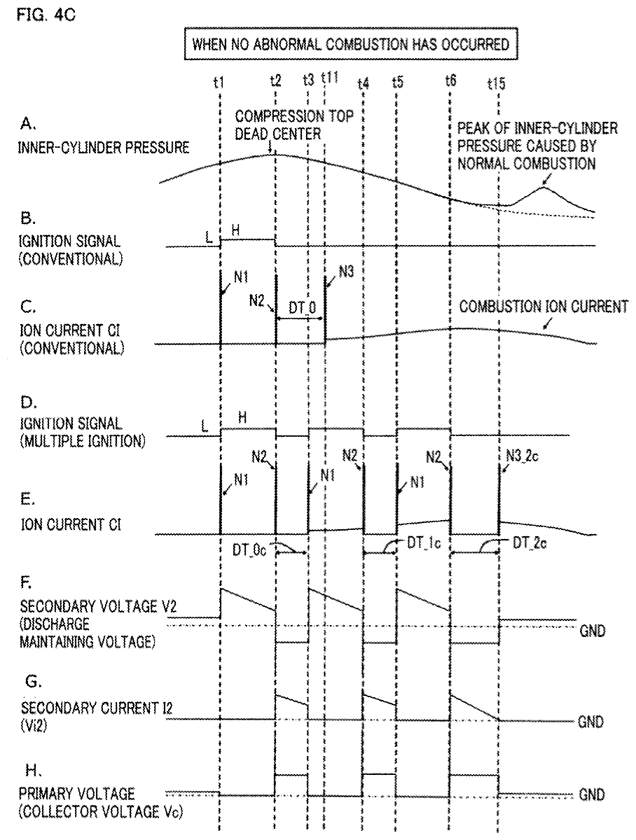

Next, the operation of the internal-combustion-engine combustion state control apparatus according to Embodiment 1 will be explained. FIG. 4A is a timing chart representing the operation of the internal-combustion-engine combustion state control apparatus according to Embodiment 1 at a time when relatively strong abnormal combustion has occurred; FIG. 4B is a timing chart representing the operation of the internal-combustion-engine combustion state control apparatus according to Embodiment 1 at a time when relatively weak abnormal combustion has occurred; FIG. 4C is a timing chart representing the operation of the internal-combustion-engine combustion state control apparatus according to Embodiment 1 at a time when no abnormal combustion has occurred.

In each of FIGS. 4A, 4B, and 4C, (A) represents an inner-cylinder pressure, (B) represents an ignition signal of a conventional apparatus to be compared with Embodiment 1, and (C) represents an ion current of the conventional apparatus to be compared with Embodiment 1; each of (D) through (H) is related to Embodiment 1 of the present disclosure; (D) represents an ignition signal for performing multiple ignition, (E) represents an ion current, (F) represents a secondary voltage V2, which is a discharge maintaining voltage, (G) represents a secondary current I2, which is a current in the secondary coil 22, and (H) represents a voltage at the primary coil 21, i.e., a primary voltage Vc, which is the collector voltage of the transistor 250. The abscissa in each of FIGS. 4A, 4B, and 4C denotes the time points. As far as the abscissa is concerned, the time point may be replaced by the rotation angle of the crankshaft 50 in the internal combustion engine.

Here, ignition control by the ignition control means 201 in the internal-combustion-engine combustion state control apparatus according to Embodiment 1 will be explained. In FIGS. 1, 2, 3, 4A, 4B, and 4C, the ignition control means 201 is configured in such a way as to generate two or more ignition signals during a single compression stroke or a single combustion stroke, i.e., in such a way as to perform so-called multiple ignition. As represented in (D) in each of FIGS. 4A, 4B, and 4C, the level of the ignition signal from the ignition control means 201 in the ECU 1 changes from a low level (hereinafter, referred to as L level) to a high level (hereinafter, referred to as H level) at a time point t1, which is a first energization-starting timing and hence the transistor 250 is turned on, so that energization of the primary coil 21 of the ignition apparatus 2 with a primary current is started.

When the primary current is applied to the primary coil 21 at the time point t1, the high voltage means 202 of the ignition apparatus 2 starts energy accumulation. As represented in (F) in each of FIGS. 4A, 4B, and 4C, the applied secondary voltage V2 gradually decreases from the time point t1. At the time point t1, the level of the primary voltage, which is a voltage at the primary coil 21, i.e., the collector voltage Vc of the transistor 250 becomes equal to the potential level of the ground potential portion GND.

Next, as represented in (D) in each of FIGS. 4A, 4B, and 4C, at a time point t2, which is a first ignition timing immediately after the ignition top death center of the internal combustion engine, the level of the ignition signal changes from H level to L level, so that the transistor 250 is turned off. As a result, the primary current that has been being applied to the primary coil 21 is cut off; then, the secondary voltage V2 as the discharge maintaining voltage is generated and is applied to the first electrode 311. As a result, a dielectric breakdown occurs in the gap 33 between the first electrode 311 and the second electrode 312, so that as represented in (G) in each of FIGS. 4A, 4B, and 4C, the secondary current I2 as the ignition discharge current starts to flow from the time point t2, which is the first ignition timing. Although gradually decreases from the time point t2, the secondary current I2 as the ignition discharge current is maintained based on the amount of energy accumulated in the high voltage means 202.

The inflammable fuel-air mixture in the combustion chamber of the cylinder 100 is ignited through an ignition discharge produced in the gap 33 and starts burning. The ignition at the time point t2 as the first ignition timing is the one under the condition that during an ignition discharge, abnormal combustion does not drastically raise the pressure and the temperature in the combustion chamber of the cylinder 100. As described above, the transistor 250 is turned off at the time point t2, so that as represented in (H) in each of FIGS. 4A, 4B, and 4C, the primary voltage at the primary coil 21, i.e., the collector voltage Vc of the transistor 250 rises in the positive-polarity direction from the potential level of the ground potential portion GND.

Next, at a time point t3 as a second energization-starting timing, the level of the ignition signal changes from L level to H level, so that the transistor 250 is turned on again and hence the primary current flows. Then, the level of the collector voltage Vc of the transistor 250, as the primary voltage, becomes equal to the potential level of the ground potential portion GND. The secondary current I2, as the ignition discharge current that has been flowing in the gap 33, is cut off at the time point t3; concurrently, the secondary voltage V2 rises from the negative-polarity side to the positive-polarity side.

Next, the level of the ignition signal represented in (D) in each of FIGS. 4A, 4B, and 4C changes from H level to L level at a time point t4, which is a second ignition timing, so that the transistor 250 is turned off. As a result, the primary current that has been being applied to the primary coil 21 is cut off; then, the secondary voltage V2, which is a negative-polarity high voltage, is generated across the secondary coil 22 and is applied to the first electrode 311. As a result, a dielectric breakdown occurs in the gap 33 between the first electrode 311 and the second electrode 312, so that as represented in (G) in each of FIGS. 4A, 4B, and 4C, the secondary current I2 as the ignition discharge current starts to flow from the time point t4.

Next, at a time point t5 as a third energization-starting timing, the level of the ignition signal changes from L level to H level, so that the transistor 250 is turned on again and hence the primary current flows. Then, the level of the collector voltage Vc of the transistor 250, as the primary voltage, becomes equal to the potential level of the ground potential portion GND. The secondary current I2, as the ignition discharge current that has been flowing in the gap 33 from the time point t4, is cut off at the time point t5, as described later, at a time when no abnormal combustion has occurred, as represented in FIG. 4C, and at a time when relatively weak abnormal combustion has occurred, as represented in FIG. 4B; concurrently, the secondary voltage V2 rises from the negative-polarity side to the positive-polarity side. The case where as represented in FIG. 4A, relatively strong abnormal combustion has occurred will be described later.

Next, the level of the ignition signal changes from H level to L level at a time point t6, which is a third ignition timing, so that the transistor 250 is turned off. As a result, the primary current that has been being applied to the primary coil 21 is cut off; then, the secondary voltage V2, which is a negative-polarity high voltage, is generated across the secondary coil 22 and is applied to the first electrode 311. As a result, a dielectric breakdown occurs in the gap 33 between the first electrode 311 and the second electrode 312, so that the secondary current I2 as the ignition discharge current starts to flow from the time point t4.

In addition, as described later, each of noise signals N1, N2, and the like flows in the ion current detection circuit 240 at each of the corresponding timings after and including the time point t1 (the energization-starting timing, the ignition timing, and the like); thus, at these timings when the respective noise signals flow, the noise signals are masked.

The time point t1, which is the first energization-starting timing, is a main energization-starting timing when energization of the primary current that flows in the primary coil 21 of the ignition apparatus 2 is started; each of the time point t3, which is the second energization-starting timing, and the time point t5, which is the third energization-starting timing, is a sub-energization-starting timing when energization of the primary current that flows in the primary coil 21 of the high voltage means 202 is started. The time point t2, which is the first ignition timing, is a main ignition timing when the primary current that flows in the primary coil 21 of the high voltage means 202 is cut off; each of the time point t4, which is the second ignition timing, and the time point t6, which is the third ignition timing, is a sub-ignition timing when the primary current that flows in the primary coil 21 of the high voltage means 202 is cut off.

As described above, there has been a problem that in the case where the ignition timing is set at a more advanced angle side in the rotation direction of the crankshaft than the foregoing timing at which abnormal combustion occurs is, the pressure and the temperature do not drastically increase during an ignition discharge and hence no abnormal combustion can be detected during the ignition discharge duration; however, in Embodiment 1 according to the present disclosure, in order to raise the abnormal-combustion detection performance, the ignition control means 201 supplies the multi-ignition signal to the ignition apparatus 2, as described above.

In Embodiment 1, application of the primary current is started again at the time point t3, which is the second energization-starting timing by which a predetermined time, e.g., approximately 300 [μs] to 500 [μs] has elapsed from the time point t2, which is the first ignition timing; the time point t4, which is the second ignition timing, is set to appear after a predetermined time, e.g., approximately 500 [μs] to 700 [μs] has elapsed from the time point t3. Similarly, the time point t5, which is the third energization-starting timing, and the time point t6, which is the third ignition timing, are set. Accordingly, as described later, the ignition discharge duration can be provided after the time point t1, which is a timing when in a conventional apparatus, the ignition discharge duration ends; thus, it is made possible to raise the abnormal-combustion detection performance.

Next, based on FIG. 4A, there will be explained the operation of the internal-combustion-engine combustion state control apparatus according to Embodiment 1 at a time when relatively strong abnormal combustion has occurred. In FIG. 4A, there is described “when abnormal combustion (strong) has occurred”; in the following explanations, “when relatively strong abnormal combustion has occurred” will be referred to as “when abnormal combustion (strong) has occurred”. As represented in (A) of FIG. 4A, when abnormal combustion (strong) has occurred, the peak of the inner-cylinder pressure, which is the pressure in the combustion chamber of the cylinder 100, occurs between the time point t4, which is the second ignition timing, and the time point t5, which is the third energization-starting timing, or more specifically, in the vicinity of the time point t5, which is the third energization-starting timing.

When the pressure and the temperature in the gap 33 between the first electrode 311 and the second electrode 312 of the ignition plug 3 drastically rise, or when a pressure change in the foregoing gap 33 causes the flow of an inflammable fuel-air mixture to increase, the ignition discharge that has been produced in the gap 33 is shifted from the original position. In this case, the path of the ignition discharge is lengthened by a distance corresponding to the one by which the ignition discharge has been shifted; as represented in FIG. 4A, the secondary voltage V2 as the discharge maintaining voltage becomes large in the negative-polarity direction during the time between the time point t4 and t12 and during the time between the time points t6 and a time point t13. When the ignition-discharge path becomes too long, the ignition discharge may be interrupted; however, as represented in (F) of FIG. 4A, in some cases, the ignition-discharge path again becomes long and the secondary voltage V2, which is the discharge maintaining voltage, frequently becomes large in the negative-polarity direction.

Accordingly, when as represented in FIG. 4A, abnormal combustion (strong) has occurred, the energy accumulated in the high voltage means 202 decreases at the time instant 12; thus, when the secondary current I2, which is an ignition discharge current, becomes lower than the level at which the ignition discharge can be maintained, the ignition discharge ends. In addition, the residual energy cannot generate the dielectric breakdown anymore; therefore, at the time point t12, there occurs LC resonance noise N3_1a that is formed by a capacitive current based on the inductance of the secondary coil 22 of the high voltage means 202 in the ignition apparatus 2, the stray capacitance at the secondary coil 22 side, and the capacitor 242.

Because the foregoing LC resonance noise N3_1a flows in the ion current detection circuit 240 represented in FIG. 3, only the ion current having a positive polarity is detected at the time point t12, as a current at a time when the secondary current I2, which is the ignition discharge current, ends. The generation width of the LC resonance noise N3_1a is approximately several tens [μs] to several hundreds [μs]. The time between the time point t4, which is the second ignition timing, and the time point t12, which is the timing when the LC resonance noise N3_1a is detected, is an ignition discharge duration DT_1a.

As described above, at the time point t12, the accumulated energy decreases and hence the ignition discharge ends; however, during the time between the time point t5, which is the third energization-starting timing, and the time point t6, which is the third ignition timing, energy is again accumulated in the high voltage means 202. However, the energy accumulated during that time also undergoes the effect of the abnormal combustion; thus, at the time point t13, the energy decreases and hence the ignition discharge ends. Accordingly, the time between the time point t6, which is the third ignition timing, and the time point t13, which is the timing when LC resonance noise N3_2a is detected, is an ignition discharge duration DT_2a.

Next, based on FIG. 4B, there will be explained the operation of the internal-combustion-engine combustion state control apparatus according to Embodiment 1 at a time when relatively weak abnormal combustion has occurred. In FIG. 4B, there is described “when abnormal combustion (weak) has occurred”; in the following explanations, “when relatively weak abnormal combustion has occurred” will be referred to as “when abnormal combustion (weak) has occurred”. As represented in (B) of FIG. 4B, when abnormal combustion (weak) has occurred, the peak of the inner-cylinder pressure, which is the pressure in the combustion chamber of the cylinder 100, occurs between the time point t5, which is the third energization-starting timing, and the time point t6, which is the third ignition timing, or more specifically, in the vicinity of the time point t6, which is the third ignition timing.

As described above, when abnormal combustion (weak) occurs, the rising timing of the pressure in the combustion chamber of the cylinder 100 is delayed, in comparison with the case where abnormal combustion (strong) occurs as represented in FIG. 4a; in FIG. 4B, the pressure and the temperature in the gap 33 do not drastically rise in the time between the time point t4, which is the second ignition timing, and the time point 5, which is the third energization-starting timing; neither no effect is provided by drastic rises in the pressure and the temperature nor no pressure change causes the inner-cylinder flow of the inflammable fuel-air mixture to increase; thus, the ignition discharge in the gap 33 is not shifted and hence the path of the ignition discharge does not become long. Therefore, unlike the case where as represented in FIG. 4A, abnormal combustion (strong) occurs, the secondary voltage V2 as the discharge maintaining voltage does not become large in the negative-polarity direction during the time between the time point t4 and the time point t5 in FIG. 4B.

When abnormal combustion (weak) occurs, the ignition discharge does not end during the time between the time point t4, which is the second ignition timing, and the time point t5, which is the third energization-starting timing; therefore, no LC resonance noise is detected. Accordingly, in this case, the ignition discharge duration becomes longer than the time between the time point t4, which is the second ignition timing and the time point t5, which is the third energization-starting timing. In the present embodiment, [DT_1b=(the time point t5−the time point t4)] is referred to as a tentative ignition discharge duration.

In contrast, in FIG. 4B, the pressure and the temperature in the gap 33 of the ignition plug 3 drastically rise after the time point t6, which is the third ignition timing; due to the effect of the drastic rise and an increase in the inner-cylinder flow of the inflammable fuel-air mixture, caused by the pressure change, the ignition discharge in the gap 33 of the ignition plug 3 is shifted from the original position; the path of the ignition discharge becomes longer by the distance corresponding to the one by which the ignition discharge has been shifted; thus, the secondary voltage V2 as the discharge maintaining voltage becomes large in the negative-polarity direction during the time between the time point t6 and a time point t14 in FIG. 4B. As a result, the accumulated energy decreases at the time point t14 in FIG. 4B and hence the ignition discharge ends. The time between the time point t6, which is the third ignition timing, and the time point t14, which is the timing when LC resonance noise N3_2b is detected, is an ignition discharge duration DT_2b.

Next, the operation of the internal-combustion-engine combustion state control apparatus according to Embodiment 1 at a time no abnormal combustion has occurred will be explained based on FIG. 4C. When no abnormal combustion has occurred, the rising timing of the pressure in the combustion chamber of the cylinder 100 is further delayed, in comparison with each of the foregoing cases where abnormal combustion (strong) occurs and where abnormal combustion (weak) occurs; thus, in FIG. 4C, the pressure and the temperature in the gap 33 of the ignition plug 3 do not drastically rise during the time between the time point t4, which is the second ignition timing, and the time point 5, which is the third energization-starting timing and after the time point t6, which is the third ignition timing; neither that effect nor the pressure change increases the inner-cylinder flow of the inflammable fuel-air mixture; the ignition discharge in the gap 33 of the ignition plug 3 is not shifted; therefore, the path of the ignition discharge does not become long.

Therefore, the secondary voltage V2 as the discharge maintaining voltage does not become so large in the negative-polarity direction as represented during the time between the time point t4 and the time point t5 and during the time between the time point t6 and a time point t15 in FIG. 4C. As described above, it is desirable that the multi-ignition signal represented in (D) of FIG. 4C is set in such a way that when no abnormal combustion has occurred, the last ignition discharge ends at the time point t15 before the timing when the pressure and the temperature rise. As a result, because the pressure-change difference between the case where no abnormal combustion has occurred and each of the cases where abnormal combustion (strong) has occurred and the where abnormal combustion (weak) has occurred becomes large, the abnormal-combustion detection performance is raised.

During the time between the time point t4, which is the second ignition timing, and the time point t5, which is the third energization-starting timing, in FIG. 4C, the ignition discharge does not end before the time point t5; therefore, no LC resonance noise is detected. Accordingly, in this case, the ignition discharge duration becomes longer than the time between the time point t4, which is the second ignition timing and the time point t5, which is the third energization-starting timing. In the present embodiment, [DT_1c=(the time point t5−the time point t4)] is referred to as the tentative ignition discharge duration.

The ignition discharge ends at the time point t15 after the time point t6, which is the third ignition timing, in FIG. 4C; thus, the time between the time point t6, which is the third ignition timing, and the time point t15, which is the timing when LC resonance noise N3_2c is detected, is the ignition discharge duration DT_2c in this case. Because as described above, the secondary voltage V2 as the discharge maintaining voltage does not become large in the negative-polarity direction, the ignition discharge duration DT_2c becomes longer than each of the foregoing ignition discharge duration DT_2a at a time when abnormal combustion (strong) has occurred and the foregoing ignition discharge duration DT_2ba at a time when abnormal combustion (weak) has occurred.

In consideration of the above facts, the relationships [DT_1a<DT_1b=DT_1c] and [DT_2a<DT_2b<DT_2c] are obtained among the ignition discharge durations; therefore, even when the time point t2, which is the main ignition timing, is set at a more advanced angle side in the rotation direction of the crankshaft 50 than the timing at which abnormal combustion occurs is, the abnormal combustion can be detected.

Moreover, in Embodiment 1, the multi-ignition signal is provided in such a way that when no abnormal combustion has occurred, the last ignition discharge ends at the time point t15 before the pressure and the temperature in the gap 33 of the ignition plug 3 rise; thus, because the difference between the ignition discharge duration at a time when no abnormal combustion occurs and the ignition discharge duration at a time when abnormal combustion occurs becomes large, the abnormal-combustion detection performance can be raised.

Although not represented, an ignition discharge in the gap 33 of the ignition plug 3 has a tendency of becoming more liable to be blown off due to the effect of inner-cylinder flow and to more repeat a dielectric breakdown, as the secondary current I2 is smaller. Accordingly, in the case where the ignition signal is set to perform multiple ignition in such a way that the secondary current I2 at a timing when abnormal combustion occurs becomes small when there occurs abnormal combustion (weak) at which the effect of an inner-cylinder flow is smaller than when there occurs abnormal combustion (strong), the abnormal-combustion detection performance at a time when abnormal combustion (weak) occurs can be raised. For example, it is desirable that the multiple-ignition ignition signal is set in such a way that the secondary current I2 at the time point t6 becomes smaller than the secondary current I2 at the time point t4 in FIG. 4B.

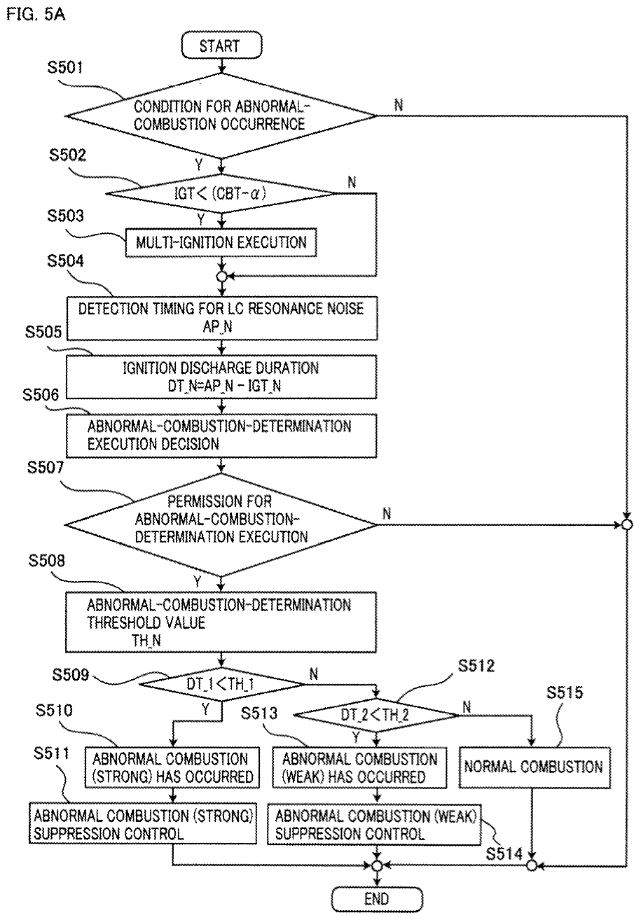

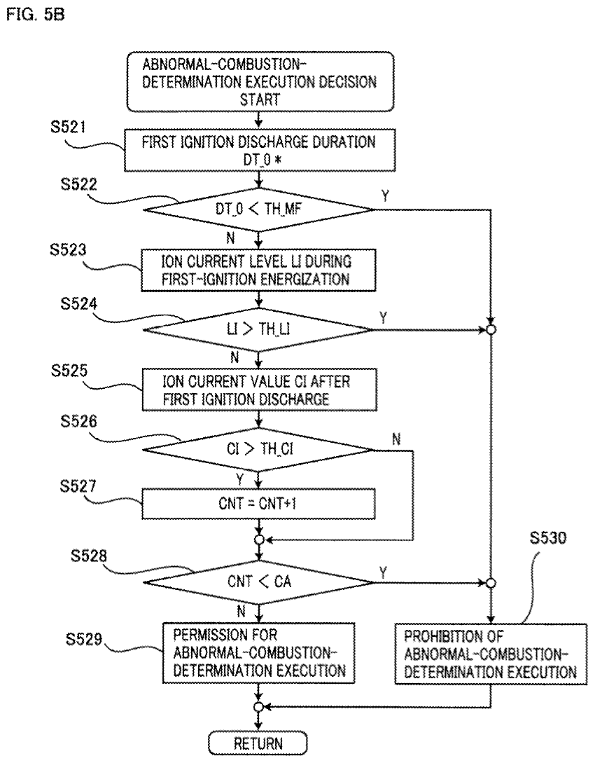

Next, there will be explained processing in ECU 1, which is the specific operation of the combustion state control apparatus according to Embodiment 1. FIG. 5A is a flowchart representing the operation of the internal-combustion-engine combustion state control apparatus according to Embodiment 1; the operation is repeated in a predetermined period. In FIG. 5A, at first, it is determined in the step S501 whether or not the operation condition is the one where abnormal combustion is liable to occur. For example, in the case where the temperature of the engine oil, the temperature of an engine cooling water, the intake air temperature, and the like are higher than respective predetermined values, the throttle opening degree is also larger than a predetermined value, and the engine rotation speed is lower than a predetermined value, it is determined that the operation condition is the one where abnormal combustion is liable to occur. In the case where in the step S501, it is determined that the operation condition is the one where abnormal combustion is liable to occur (Y), the step S501 is followed by the step S502.

In the step S502, it is determined whether or not an ignition timing IGT is at a more advanced angle side in the rotation direction of the crankshaft 50 than [CBT-α] calculated from an abnormal combustion occurrence timing CBT, which has preliminarily been ascertained by an experiment, and a obtained by converting the average value of ignition discharge durations into an crank angle, i.e., whether or not [IGT<(CBT-α))]. In the case where in the step S502, it is determined that [IGT<(CBT-α)] (Y), the step S502 is followed by the step S503. The value α may be either a value obtained by converting the minimum value among ignition discharge durations into a crank angle or [CBT-α+β] obtained by providing a margin degree β. This manner described above makes it possible to perform multiple ignition only when it is required; therefore, it is made possible to reduce abrasion of the ignition plug 3 and heat generation caused by application of a primary current of the ignition apparatus 2, an increase in the ignition discharge duration, and the like.

In the step S503, there is performed an instruction that the ignition signal to be outputted from the ignition control means 201 should be set to an multiple-ignition ignition signal. As explained in each of FIGS. 4A, 4B, and 4C, in the multiple ignition, application of the primary current is started again at the time point t3, which is the second energization-starting timing, by which a predetermined time has elapsed from the time point t2, which is the first ignition timing; furthermore, there is set the time point t4, which is the second ignition timing, by which a predetermined time has elapsed from the time point t3. Similarly, the time point t5, which is the third energization-starting timing, and the time point t6, which is the third ignition timing, are also set. As a result, in the case of the conventional single ignition signal represented in (B) of each of FIGS. 4A, 4B, and 4C, the ignition discharge ends at the timing of the time point t11; however, in the multiple ignition in Embodiment 1, the ignition discharge duration can be set at a time point other than the time point t11.

Although not represented, in the case where the foregoing ignition timing IGT and abnormal combustion occurrence timing CBT are largely separated from each other, e.g., in the case where [CBT-IGT] is three times or more larger than a value obtained by converting [time point t4−time point t2] into an crank angle, the time between the time point t2, which is the first ignition timing, and the time point t3, which is the second energization-starting timing, is made longer. For example, the time between the time point t2, which is the first ignition timing, and the time point t3, which is the second energization-starting timing, is set to a value obtained by adding [time point t3−time point t2] to the value twice as large as [time point t4−time point t2]. Accordingly, it is made possible that the timing at which the pressure and the temperature drastically rise during ignition discharge, due to the occurrence of abnormal combustion (strong) or abnormal combustion (weak), is made to occur after the time between the time point t4, which is the second ignition timing, and the time point 5, which is the third energization-starting timing, and after the time point t6, which is the third ignition timing.

In other words, the time between the time point t2, which is the first ignition timing, and the time point t3, which is the second energization-starting timing, is changed in accordance with the ignition timing IGT. As a result, it is not required to further add multiple ignition between the time point t2 and the time point t3; therefore, it is made possible to reduce abrasion of the ignition plug 3 and heat generation caused by application of a primary current of the ignition apparatus 2, an increase in the ignition discharge duration, and the like.

As explained in each of FIGS. 4A, 4B, and 4C, in Embodiment 1, the ignition apparatus 2 accumulates energy each time the ignition signal is H-level and makes ignition discharge occur in the gap 33 of the ignition plug 3 at each of the ignition timings. Then, when the accumulated energy decreases in each of the ignition discharge durations and hence the ignition discharge ends, LC resonance noise is detected, as the current at a time when the spark discharge ends.

That is to say, when as represented in FIG. 4A, abnormal combustion (strong) occurs, the LC resonance noise N3_1a occurs at the time point t12 at which the ignition discharge ends and the LC resonance noise N3_2a occurs at the time point t13 at which the ignition discharge ends; then, the ion current detection circuit 240 in the ignition-discharge parameter detection circuit 203 detects these LC resonance noise signals. When as represented in FIG. 4B, abnormal combustion (weak) occurs, the LC resonance noise N3_2b occurs at the time point t14 at which the ignition discharge ends; then, the ion current detection circuit 240 in the ignition-discharge parameter detection circuit 203 detects this LC resonance noise. As described above, through the signal reception device 204, ECU 1 obtains a signal based on LC resonance noise from the ion current detection circuit 240 of the ignition apparatus 2.

Returning to FIG. 5A, in the step S504, an LC resonance noise generation timing AP_N is obtained from the signal obtained through the signal reception means 204. In the present embodiment, the LC resonance noise generation timing AP_N corresponds to each of the time points t12 and t13 in FIG. 4A and the time point t14 in FIG. 4B.

Next, in the step S505, from the obtained LC resonance noise generation timing AP_N and each ignition timing IGT_N, each ignition discharge duration DT_N is calculated by [DT_N=AP_N−IGT_N]. In the present embodiment, each ignition timing IGT_N corresponds to the time point t4 or t6 in each of FIGS. 4A, 4B, and 4C. The ignition discharge duration DT_N corresponds to DT_1a or DT_2a in FIG. 4A and DT_2b in FIG. 4B. The respective processing items in the steps S504 and S505 are performed by the ignition-discharge duration detection means 205.

In the step S506, an abnormal-combustion-determination execution decision is implemented. The detail of the processing in the step S506 will be represented in FIG. 5. FIG. 5B is a flowchart representing the operation of an abnormal-combustion-determination execution decision in the internal-combustion-engine combustion state control apparatus according to Embodiment 1. In FIG. 5B, at first, in the steps S521 and D522, it is determined whether or not a discharge abnormality exists in the ignition plug 3.

Specifically, in the step S521, the ignition discharge duration DT_0* (* indicates any one of a, b, and c) between the time point t2 and the time point t3 before abnormal combustion occurs, represented in each of FIGS. 4A, 4B, and 4C, is calculated, as is the case with the step S505. In the present embodiment, the ignition discharge duration DT_0* corresponds to any one of DT_0a in FIG. 4A, DT_0b in FIG. 4B, and DT_0c in FIG. 4C. Next, in the step S522, it is determined whether or not the foregoing calculated ignition discharge duration DT_0* is shorter than a predetermined threshold value TH_MF. In the case where it is determined in the step S522 that the calculated ignition discharge duration DT_0* is shorter than the predetermined threshold value TH_MF (Y), the step S522 is followed by the step S530, where the abnormal-combustion determination is prohibited; in the case where calculated ignition discharge duration DT_0* is not shorter than the predetermined threshold value TH_MF (N), the step S522 is followed by the step S523.

When the secondary voltage V2, which is a negative-polarity high voltage produced across the secondary coil 22 of the ignition apparatus 2, is transferred to the first electrode 311 of the ignition plug 3, the secondary voltage V2 causes a dielectric breakdown to occur in the gap 33 between the first electrode 311 and the second electrode 312; then, the secondary current I2, which is an ignition discharge current, starts to flow therein. The secondary current I2 as the ignition discharge current is maintained for a time corresponding to the energy accumulated in the high voltage means 202; however, when not a dielectric breakdown but a discharge abnormality occurs in the gap 33, the ignition discharge duration becomes extremely short. Accordingly, for example, the threshold value TH_MF is set to a short time of approximately 0.1 [ms] to 0.2 [ms] so as to determine whether or not a discharge abnormality exists in the ignition plug 3; then, in the case where a discharge abnormality exists, execution of the abnormal-combustion determination is prohibited, so that abnormal combustion can be prevented from being erroneously detected.

Next, in the steps S523 and S524, a leakage state of the ignition plug 3 is diagnosed. At first, in the step S523, an ion current level LI during a first ignition energization is calculated; then, in the step S524, it is determined whether or not the ion current level LI during the first ignition energization is larger than a predetermined threshold value TH_LI. In the case where it is determined that the ion current level LI during the first ignition energization is larger than the predetermined threshold value TH_LI (Y), the step S524 is followed by the step S530, where execution of the abnormal-combustion determination is prohibited; in the case where the ion current level LI during the first ignition energization is not larger than the predetermined threshold value TH_LI (N), the step S524 is followed by the step S525.

In some cases, due to incomplete combustion of an inflammable fuel-air mixture, carbon adheres to the first electrode 311 of the ignition plug 3, the second electrode 312 whose electric potential is equal to that of the ground potential portion GND, and the like, and the insulating resistance decreases due to a pile of the carbon adhered thereto; in these cases, a leakage current flows in the ion current path during the first ignition-discharge energization before combustion, e.g., the time between the time point t1 and the time point t2 in FIG. 4A.

As is well known, carbon piles up at the rear portion (root portion) of an insulator covering the circumference of the second electrode 312 of the ignition plug 3 spreads on the surface of the insulator and reaches the space between the first electrode 311 of the ignition plug 3 and a mounting metal fitting whose potential is maintained to be equal to the ground potential; as a result, there occurs a situation in which a path of the leakage current is formed in such a way as to short-circuit the space between the first electrode 311, which is the main electrode, and the mounting metal fitting. When an ignition discharge occurs in this situation, the ignition-discharge path becomes long due to the effect of the leakage-current path and hence the secondary voltage V2 as the discharge maintaining voltage becomes large in the negative-polarity direction. In other words, the ignition discharge duration is shortened. Accordingly, for example, the threshold value TH_LI is set to [the secondary voltage V2 during the first ignition discharge/the insulating resistance value] so as to diagnose the leakage state and execution of the abnormal-combustion determination is prohibited when a leakage occurs, so that abnormal combustion can be prevented from being erroneously detected. In this situation, the insulating resistance value is approximately 1 [MΩ] to 10 [MΩ].

In the steps S525 through S528, combustion and a misfire of an inflammable fuel-air mixture are determined. At first, in the step 3525, an ion current value CI after a first ignition discharge is obtained; then, in the step S526, it is determined whether or not the ion current value CI obtained after the first ignition discharge is larger than a predetermined threshold value TH_CI. In the case where the ion current value CI is larger than the predetermined threshold value TH_CI (Y), the step S526 is followed by the step S527, where a counter value CNT is increased by “1”; then, the step S527 is followed by the step 3528. The counter value CNT is reset to “0” at each of the first-ignition timings.

In the step S528, it is determined whether or not the counter value CNT is smaller than a combustion-determination counter threshold value CA; in the case where the counter value CNT is smaller than the combustion-determination counter threshold value CA (Y), it is determined that a misfire has occurred; next, the execution of the abnormal-combustion determination is prohibited in the step S530. When the counter value CNT is larger than the combustion-determination counter threshold value CA, it is determined in the step S528 that combustion has occurred (N); then, the step S528 is followed by the step S529, where execution of the abnormal-combustion determination is permitted.

In some cases, a misfire occurs due to incomplete combustion of an inflammable fuel-air mixture; in that situation, no ion current flows after the first ignition discharge, e.g., after the time point t2 in FIG. 4A. During the misfire, no ion caused by combustion is produced in the gap 33 between the first electrode 311 and the second electrode 312 of the ignition plug 3; thus, in comparison with the time of combustion, the secondary voltage V2 as the discharge maintaining voltage becomes large in the negative-polarity direction. In other words, the ignition discharge duration is shortened during the extinction. Accordingly, for example, the threshold value TH_CI is set to approximately 4 [μA] so as to determine whether combustion has occurred or a misfire has occurred, and execution of the abnormal-combustion determination is prohibited when a misfire has occurred; as a result, abnormal combustion can be prevented from being erroneously detected.

After the foregoing abnormal-combustion-determination execution decision according to FIG. 5B is implemented in the step S506 in FIG. 5A, the processing cycle moves to the next one; in the case where in the abnormal-combustion-determination execution decision in the step S507, it is determined that execution of the abnormal-combustion determination is permitted (Y), the step S507 is followed by the step S508, where an abnormal-combustion determination threshold value TH_N (N is any one of 1 and 2) for each of the ignition discharge durations is set. In the case where when as represented in FIG. 4C, no abnormal combustion has occurred, the ignition discharge does not end during the time between the time point t4 and the time point t5 and hence no LC resonance noise is detected, it is only necessary to set an abnormal-combustion determination threshold value TH_1 to [the time point t5−the time point t4].

Although not represented in the drawings, if the ignition discharge ends during the time between the time point t4 and the time point t5 and LC resonance noise is detected, it is only necessary that the margin degree β is added to the average value of LC resonance noise generation timings AP_1 or the minimum value CAL(AP_1) thereof and then the abnormal-combustion determination threshold value TH_1 is set to [CAL(AP_1)−the time point t4−the margin degree β]. Similarly, because the ignition discharge ends during the time between the time point t6 and the time point t15 in FIG. 4C and the LC resonance noise N3_2c is detected, it is only necessary that the margin degree β is added to the average value of LC resonance noise generation timings AP_2 or the minimum value CAL(AP_2) thereof and then the abnormal-combustion determination threshold value TH_2 is set to [CAL(AP_2)−the time point t6−the margin degree β].

Next, in the step S509, it is determined whether or not an ignition discharge duration DT_1 in the time between the time point t4, which is the second ignition timing, and the time point t5, which is the third energization-starting timing, among the ignition discharge durations calculated in the step S505, is shorter than the foregoing abnormal-combustion determination threshold value TH_1. In the case where the ignition discharge duration DT_1 is shorter than the foregoing abnormal-combustion determination threshold value TH_1 (Y), the step S509 is followed by the step S510, where it is determined that abnormal combustion (strong) has occurred; then, the step S510 is followed by the step S511. When as represented in FIG. 4A, abnormal combustion (strong) has occurred, [DT_1a<TH_1] is established; thus, it can be determined that abnormal combustion (strong) has occurred.

In the step S511, in order to suppress abnormal combustion (strong) from occurring, there is performed control in which the amount of the fuel to be injected by the fuel injection valve 6 is increased so that the inner-cylinder temperature is decreased by fuel vaporization heat or control in which the valve driving mechanism 10 changes the timing for closing the intake valve 4 so that the effective compression ratio is decreased and hence the temperature of the inflammable fuel-air mixture is suppressed from being raised by the compression. In addition, other methods may be implemented, as long as they are to prevent the high-temperature state of the inflammable fuel-air mixture from continuing for a long time.

In contrast, in the case where it is determined in the step S509 that the ignition discharge duration DT_1 is the same as or larger than the abnormal-combustion determination threshold value TH_1 (N), the step S509 is followed by the step S512. When as represented in FIG. 4B, abnormal combustion (weak) has occurred, it is not determined in the step S509 that [DT_1b<TH_1] (N) and when as represented in FIG. 4C, no abnormal combustion has occurred, it is not determined in the step S509 that [DT_1c<TH_1] (N); therefore, the step S509 is followed by the step S512.

In the step S512, it is determined whether or not an ignition discharge duration DT_2 in the time after the time point t6, which is the third ignition timing, among the ignition discharge durations calculated in the step S505, is shorter than the foregoing abnormal-combustion determination threshold value TH_2. In the case where the ignition discharge duration DT_2 is shorter than the abnormal-combustion determination threshold value TH_2 (Y), the step S512 is followed by the step S5103, where it is determined that abnormal combustion (weak) has occurred. When as represented in FIG. 4B, abnormal combustion (weak) has occurred, [DT_2b<TH_2] is established; therefore, it can be determined that abnormal combustion (weak) has occurred.

In the step S514, as is the case with the foregoing step S511, in order to suppress abnormal combustion (weak) from occurring, there is performed control in which the amount of the fuel to be injected is increased or control in which the timing for closing the intake valve 4 is changed so that the effective compression ratio is decreased. The increase in the fuel-injection amount or the decrease in the effective compression ratio for suppressing the occurrence of abnormal combustion (weak) may be reduced in comparison with the case where abnormal combustion strong) occurs. As a result, the output at a time when abnormal combustion (weak) occurs can be prevented from being reduced by increasing the fuel-injection amount more than necessary or by decreasing the effective compression ratio more than necessary.

In the case where it is determined in the step 3512 that the ignition discharge duration DT_2 is the same as or larger than the abnormal-combustion determination threshold value TH_2 (N), the step S512 is followed by the step S515, where it is determined that the combustion is the normal one. When as represented in FIG. 4C, no abnormal combustion has occurred, [DT_2c<TH_2] is not established (N); therefore, it can be determined that no abnormal combustion has occurred, i.e., that the combustion is the normal one.

Although not represented, in the case where a pressure change due to abnormal combustion occurs in the time between the time point t2 and the time point t3 in each of FIGS. 4A, 4B, and 4C, an abnormal-combustion determination threshold value TH_0 is set for each of the ignition discharge durations DT_0a, DT_0b, and DT_0c in that respective times, so that determination of abnormal combustion can be performed.

Moreover, the abnormal-combustion determination threshold value TH_N may be set as a map value for each of operation conditions such as the rotation speed, the load, and the ignition timing of the internal combustion engine. Furthermore, because the energy accumulated by the ignition apparatus 2 changes depending on the battery voltage, which is the power source for the ignition apparatus 2, it may be allowed that the abnormal-combustion determination threshold value TH_N is set as a map value corresponding to the power source voltage.

In the case where a pressure change due to abnormal combustion occurs in the time between the time point t1 and the time point t2 in each of FIGS. 4A, 4B, and 4C, a combustion ion current is generated before the time point t2, which is the first ignition timing; thus, determination of abnormal combustion can be performed by detecting the combustion ion current. In that case, multiple ignition after the time point t2, which is the first ignition timing, is not required; therefore, it may be allowed that multiple ignition is not performed so as to reduce abrasion of the ignition plug 3 and that heat generation, caused by application of a primary current of the ignition apparatus 2 or by an increase in the ignition discharge duration, is reduced.

The processing items in the steps S508 through S510, steps S512 through S514, and the step S515 are performed by the abnormal-combustion determination means 206, and the processing items in the steps S511 and S514 are performed by the abnormal-combustion-suppression control means 207.

The foregoing internal-combustion-engine combustion state control apparatus according to Embodiment 1 makes it possible to accurately perform detection of abnormal combustion; therefore, because it is made possible to raise the engine efficiency, the internal-combustion-engine combustion state control apparatus can contribute to the environment preservation and to the solution of the problem of fuel depletion.

Moreover, the ignition signal, as the instruction of applying the primary current, is generated two or more times between a single compression stroke and a single combustion stroke of an internal combustion engine; therefore, because the ignition discharge duration can be provided even after the timing when in a conventional apparatus, the ignition discharge duration ends, the abnormal-combustion detection performance can be raised.

Moreover, the abnormal-combustion determination means 206 has a comparison level means that sets two or more comparison levels to be compared with two or more ignition discharge durations, and diagnoses that combustion is abnormal, when at least one of the two or more ignition discharge durations is the same as or lower than a set comparison level; therefore, not only whether or not abnormal combustion has occurred but also the strength of the abnormal combustion, i.e., abnormal combustion (strong) and abnormal combustion (weak) in Embodiment 1, can be determined; thus, the abnormal-combustion-suppression control means 207 can be operated in accordance with the determination.

Moreover, the abnormal-combustion determination means 206 has a discharge-abnormality diagnosis means for diagnosing whether or not an discharge abnormality exists in the ignition plug 3, and prohibits the diagnosis of a combustion state, when the discharge-abnormality diagnosis means diagnoses that the discharge is abnormal; therefore, even when no dielectric breakdown occurs in the gap 33 of the ignition plug 3 and hence the discharge becomes abnormal, abnormal combustion can be prevented from being erroneously detected.

Moreover, the abnormal-combustion determination means 206 has a leakage diagnosis means for diagnosing a leakage state of the ignition plug 3, and prohibits the diagnosis of a leakage state, when the leakage diagnosis means diagnoses that there exists leakage exceeding a predetermined level; therefore, abnormal combustion can be prevented from being erroneously detected when leakage exists.

Moreover, the abnormal-combustion determination means 206 has a misfire diagnosis means for diagnosing whether combustion has occurred or a misfire has occurred, and prohibits the diagnosis of a combustion state, when the misfire diagnosis means diagnoses that a misfire has occurred; therefore, abnormal combustion can be prevented from being erroneously detected when a misfire occurs.

Moreover, because after a duration the same as or longer than an ignition discharge duration, caused by the first ignition signal among two or more ignition signals, has elapsed, the ignition control means 201 generates the next ignition signal, it is not required that even when the ignition timing IGT and the abnormal combustion occurrence timing CBT are largely separated from each other, multiple ignition is further added; thus, it is made possible to reduce abrasion of the ignition plug 3 and heat generation caused by application of a primary current of the ignition apparatus 2 or an increase in the ignition discharge duration.

Furthermore, the ignition-discharge parameter detection circuit 203 has an ion current detection circuit that detects an electric quantity based on an ion generated in the combustion chamber, when an inflammable fuel-air mixture in the combustion chamber combusts due to an ignition discharge; therefore, the diagnosis of whether or not a discharge abnormality exists, the diagnosis of a leakage state of the ignition plug 3, and the diagnosis of whether combustion has occurred or a misfire has occurred can be performed.

Moreover, the ignition-discharge duration detection means 205 has a masking means that masks the respective output signals of the ion current detection circuit 240 in the vicinity of the energization-starting timing at which the ignition control means 201 starts application of a primary current and in the vicinity of the ignition timing at which the ignition control means 201 cuts off the primary current and performs an ignition discharge, and the ignition-discharge duration detection means 205 detects the ignition discharge duration, based on the output signal other than the masked ones; therefore, it is made possible to prevent abnormal combustion from being erroneously detected due to the noise signals N1 and N2 represented in each of FIGS. 4A, 4B, and 4C.

### Embodiment 2

Next, an internal-combustion-engine combustion state control apparatus according to Embodiment 2 will be explained. In foregoing Embodiment 1, as in the step S505 represented in FIG. 5A, the respective ignition discharge durations DT_1 and DT_2 are calculated; however, in the internal-combustion-engine combustion state control apparatus according to Embodiment 2, an abnormal-combustion determination threshold value TH_1 for abnormal combustion (strong) and an abnormal-combustion determination threshold value TH_2 for abnormal combustion (weak) are provided for the last ignition discharge duration DT_2 so that the last ignition discharge duration DT_2 is compared with each of these abnormal-combustion determination threshold values.

In the time between the time point t4 and the time point t5 in FIG. 4A at a time when abnormal combustion (strong) has occurred, energy is consumed due to the effect of the occurrence of the abnormal combustion (strong), in comparison with the case where no abnormal combustion has occurred; therefore, the discharge ends at the time point t12, and the energy becomes “0” at the time point t5. In contrast, in the time between the time point t4 and the time point t5 at each of time when as represented in FIG. 4B, abnormal combustion (weak) has occurred and time when as represented in FIG. 4C, no abnormal combustion has occurred, the effect of the abnormal combustion is small or negligible; thus, at the time point t5, the energy accumulated in the high voltage means 202 remains.

Accumulation of energy is started again from the time point t5; however, because there exist a difference between the initial energy at the time point t5 in the case where abnormal combustion (strong) has occurred and the initial energy at the time point t5 in each of the cases where abnormal combustion (weak) has occurred and where no abnormal combustion has occurred, there exist also a difference between the energy at the time point t6 in the case where abnormal combustion (strong) has occurred and the energy at the time point t6 in each of the cases where abnormal combustion (weak) has occurred and where no abnormal combustion has occurred, and the energy at the time point t6 in the case where abnormal combustion (strong) has occurred is smaller than the energy at the time point t6 in each of the cases where abnormal combustion (weak) has occurred and where no abnormal combustion has occurred.

In other words, the last ignition discharge duration DT_2 includes the effect of the immediately previous ignition discharge duration DT_1 (the ignition discharge duration between the time point t4 and the time point t5). Accordingly, the respective abnormal-combustion determination threshold values are set in such a way that the abnormal-combustion determination threshold value TH_2 at a time of abnormal combustion (weak)>the abnormal-combustion determination threshold value TH_1 at a time of abnormal combustion (strong); when [DT_2<TH_1] is established, it can be determined that abnormal combustion (strong) has occurred; when [TH_1−DT_2<TH_2] is established, it can be determined that abnormal combustion (weak) has occurred; in other cases, it can be determined that no abnormal combustion has occurred.

The block diagram in FIG. 2, representing the configuration of the internal-combustion-engine combustion state control apparatus, and the circuit diagram in FIG. 3, representing the ignition apparatus, in Embodiment 1 are applied also to Embodiment 2.

In the foregoing internal-combustion-engine combustion state control apparatus according to Embodiment 2, the abnormal-combustion determination means 206 has a comparison level means that sets two or more threshold values as comparison levels to be compared with the last ignition discharge duration among two or more ignition discharge durations, and diagnoses that combustion is abnormal, when the last ignition discharge duration is the same as or lower than any one of the set comparison levels; therefore, not only whether or not abnormal combustion has occurred but also the strength of each of abnormal combustion (strong) and abnormal combustion (weak) can be determined; thus, the abnormal-combustion-suppression control means can be operated in accordance with the determination. Moreover, because abnormal combustion is determined by use of only the last ignition discharge duration Dt_2 among two or more ignition discharge durations, calculation processing for the ignition discharge duration DT_1 is not necessary; thus, the processing load on ECU 1 can be reduced.

### Embodiment 3

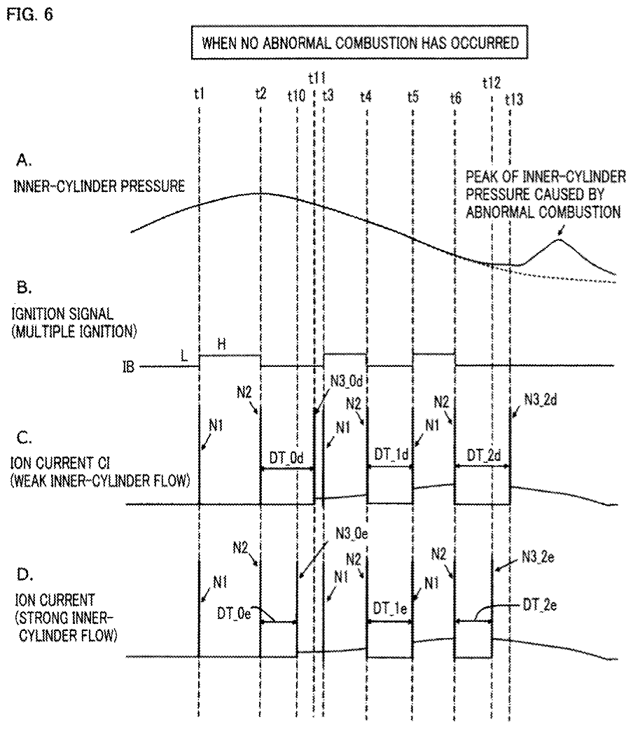

Next, an internal-combustion-engine combustion state control apparatus according to Embodiment 3 will be explained. FIG. 6 is a timing chart representing the operation of an internal-combustion-engine combustion state control apparatus according to Embodiment 3; (A) represents an inner-cylinder pressure, (B) represents an ignition signal for performing multiple ignition, (C) represents an ion current at a time when the inner-cylinder flow is relatively weak, and (D) represents an ion current at a time when the inner-cylinder flow is relatively strong; the abscissa denotes the time points. As far as the abscissa is concerned, the time point may be replaced by the rotation angle of the crankshaft 50 in the internal combustion engine.

In foregoing Embodiment 1, by adding a margin degree (i to the average value of preliminarily and experimentally ascertained LC resonance noise generation timings AP_N at a time when no abnormal combustion has occurred or to the minimum value CAL(AP_N), the abnormal-combustion determination threshold value is set in such a way that (the abnormal-combustion determination threshold value TH_N=CAL(AP_N)−each of the ignition timings [the time point t4, the time point t6)−the margin degree β]; however, in the internal-combustion-engine combustion state control apparatus according to Embodiment 3, a correction value γ is provided in such a way that the abnormal-combustion determination threshold value is corrected in accordance with the state of the inner-cylinder flow of an inflammable fuel-air mixture.

As described above, in the case where abnormal combustion (strong) represented in FIG. 4A according to Embodiment 1 occurs, the ignition-discharge path becomes longer corresponding to a distance by which an ignition discharge in the gap 33 of the ignition plug 3 has been shifted due to the effect of drastic rises of the pressure and the temperature in the gap 33 of the ignition plug 3 or an increase in the inner-cylinder flow of the inflammable fuel-air mixture, caused by the pressure change; therefore, as represented in the time between the time point t4 and the time point t6 and in the time between the time point t6 and the time point t13 in FIG. 4A, the secondary voltage V2, which is a discharge magnetic-flux voltage, becomes large in the negative-polarity direction.

In contrast, when as represented in FIG. 4C, no abnormal combustion has occurred, the rising timing of the pressure in the gap 33 of the ignition plug 3 is further delayed, in comparison with each of the foregoing cases where abnormal combustion (strong) occurs and where abnormal combustion (weak) occurs; therefore, in FIG. 4C, the pressure and the temperature in the gap 33 of the ignition plug 3 do not drastically rise during the time between the time point t4, which is the second ignition timing, and the time point 5, which is the third energization-starting timing and after the time point t6, which is the third ignition timing; thus, because neither the effect of the drastic rise is provide nor the inner-cylinder flow is increased by the pressure change, the ignition discharge in the gap 33 of the ignition plug 3 is not shifted and hence the ignition-discharge path does not become long.

Therefore, the secondary voltage V2 as the discharge maintaining voltage does not become so large in the negative-polarity direction as represented during the time between the time point t4 and the time point t5 and during the time between the time point t6 and a time point t15 in FIG. 4C. However, even when as represented in FIG. 4c, no abnormal combustion has occurred, the intake valve 4 opens in the intake stroke, and then the compression stroke and the combustion stroke cause an inner-cylinder flow of the inflammable fuel-air mixture to occur. In addition, even when no abnormal combustion has occurred, the inner-cylinder flow changes depending on the operation state of the internal combustion engine, for example, in comparison with the case where the pressure in the combustion chamber of the cylinder 100 is not high, the inner-cylinder flow of the inflammable fuel-air mixture increases when the pressure in the combustion chamber of the cylinder 100 is high. That is to say, because the inner-cylinder flow varies due to various kinds of effects, it is desirable that the foregoing abnormal-combustion determination threshold value is corrected in accordance with the state of the inner-cylinder flow.

Accordingly, as represented in FIG. 6, in the time between the time point t2 and the time point t3, which is the first-half time of multiple ignition and in which the pressure and the temperature do not drastically rise during an ignition discharge in any of the cases where abnormal combustion (strong) occurs, where abnormal combustion (weak) occurs, and where no abnormal combustion occurs, the first-half time of multiple ignition is set so as to be longer than a conventional ignition discharge duration DT_0d (the time between the time point t2 and the time point t11) at a time when no multiple ignition is performed. As a result, as represented in FIG. 6, LC resonance noise signals N3_0d and N3_0e can be detected in the first-half time of multiple ignition, and the ignition discharge durations DT_0d and DT_0e can also be detected.

As described above, even when no abnormal combustion has occurred, an inner-cylinder flow occurs; as represented in FIG. 6, the ignition discharge duration DT_0e at a time when the inner-cylinder flow is relatively strong becomes shorter than the ignition discharge duration DT_0d at a time when the inner-cylinder flow is relatively weak. The reason therefor is that although in comparison with each of the cases where abnormal combustion (strong) occurs and where abnormal combustion (weak) occurs, the effect to an ignition discharge is small, an increase in the inner-cylinder flow makes the ignition discharge in the gap 33 of the ignition plug 3 flow; thus, the ignition-discharge path becomes long and hence the secondary voltage V2 as the discharge maintaining voltage becomes large in the negative-polarity direction.

Accordingly, when the inner-cylinder flow is relatively strong, the abnormal-combustion determination threshold value is set to [TH_N2=TH_N−correction value γ] by providing the correction value γ, which is calculated based on the ignition discharge duration DT_0e at a time when the inner-cylinder flow is strong, in the foregoing [the abnormal-combustion determination threshold value TH_N=CAL(AP_N)−each of the ignition timings (the time point t4, the time point t6)−the margin degree 3).

Provided a preliminarily and experimentally ascertained ignition discharge duration is DT_0d at a time when the inner-cylinder flow is relatively weak, the correction value γ is calculated by ((DT_0d−DT_0e)×coefficient K]. When the respective energy amounts accumulated by the ignition apparatus 2 at the time points t2, t4, and t6 are equal to one another, the coefficient K may be set to “1”. Conversely, it may be allowed that the coefficient K is set to “1” and then multiple ignition is performed in such a way that the respective energy amounts accumulated by the ignition apparatus 2 become equal to one another. Moreover, in the case where it is known through an experiment that the respective inner-cylinder flows in the time between the time point t2 and the time point t3, in the time between the time point t4 and the time point t5, and in the time after and including the time point t6 are different from one another, it may be allowed that the effect is included in the coefficient K.

In the foregoing internal-combustion-engine combustion state control apparatus according to Embodiment 3, because after a duration the same as or longer than an ignition discharge duration, caused by the first ignition signal among two or more ignition signals, has elapsed, the ignition control means generates the next ignition signal, and because as far as the comparison level means, there is provided a comparison level correction means that corrects the comparison level, based on the first-half ignition discharge duration among two or more ignition discharge durations, it is made possible to prevent a combustion state from being erroneously detected due to variations in the inner-cylinder flow.

### Embodiment 4

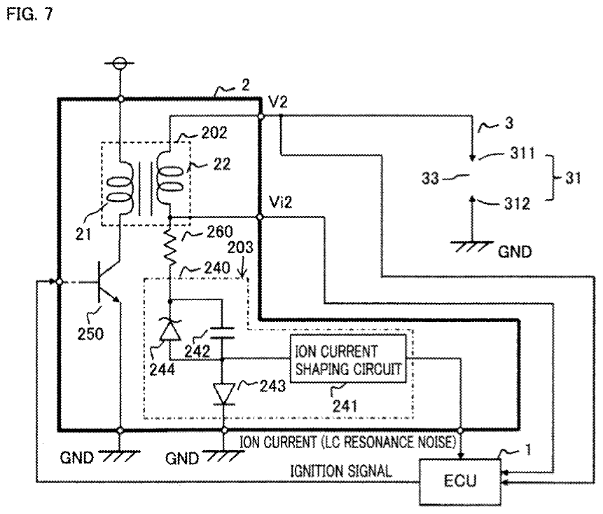

Next, an internal-combustion-engine combustion state control apparatus according to Embodiment 4 will be explained. FIG. 7 is a circuit diagram representing an example of an ignition apparatus in the internal-combustion-engine combustion state control apparatus according to Embodiment 4. In foregoing Embodiment 1, as represented in FIG. 3, as an example of the ignition-discharge parameter detection circuit 203, there is provided an ion current detection circuit 240 so that an ignition discharge duration is detected; however, instead, in Embodiment 4, as represented in FIG. 7, a resistor 260 is connected between the secondary coil 22 and the ion current detection circuit 240 so that the secondary current, which is an ignition discharge current, is obtained as a voltage Vi2, and then the voltage Vi2 is inputted to ECU 1 so that the ignition discharge duration is detected. In addition, it is also made possible to detect the ignition discharge duration, by detecting a time during which as represented in each of FIGS. 4A, 4B, and 4C, the secondary current, which is the ignition discharge current, is flowing.

Moreover, it may be allowed that as represented in FIG. 7, the secondary voltage V2 between the secondary coil 22 and the ignition plug 3 is inputted to ECU 1 so that the ignition discharge duration is detected. It is also made possible to detect the ignition discharge duration, by detecting a time during which as represented in each of FIGS. 4A, 4B, and 4C, the secondary voltage, which is an ignition-discharge maintaining voltage that is large at the negative-polarity side of the potential level of the ground potential portion GND, is generated.

In the foregoing internal-combustion-engine combustion state control apparatus according to Embodiment 4, the ignition-discharge parameter detection circuit 203 detects the ignition discharge current in the ignition apparatus 2 or the ignition-discharge maintaining voltage; thus, even when it is not made possible to set the AD-conversion sampling rate of ECU 1 to approximately several [μs] to several tens [μs], an effect the same as that of Embodiment 1 can be obtained.

### Embodiment 5

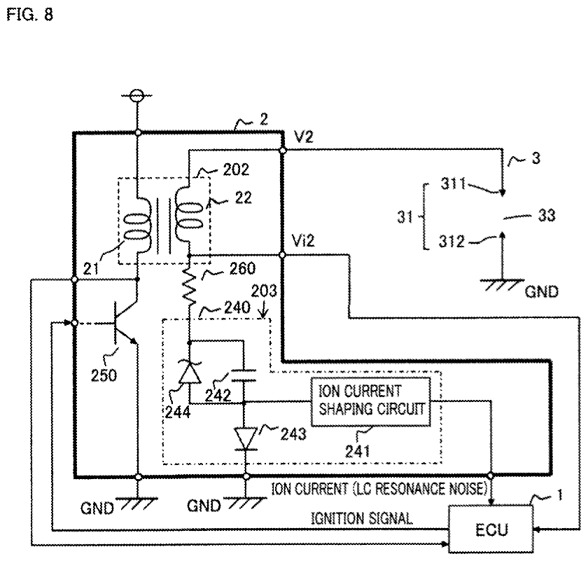

Next, an internal-combustion-engine combustion state control apparatus according to Embodiment 5 will be explained. FIG. 8 is a circuit diagram representing an example of an ignition apparatus in the internal-combustion-engine combustion state control apparatus according to Embodiment 5. In each of foregoing Embodiments 1 and 4, as represented in FIG. 7, the secondary voltage V2 between the secondary coil 22 and the ignition plug 3 is inputted to ECU 1 so that the ignition discharge duration is detected; however, instead, in the internal-combustion-engine combustion state control apparatus according to Embodiment 5, as represented in FIG. 8, the collector voltage Vc of the transistor 250 is inputted to ECU 1 so that the ignition-discharge maintaining voltage is detected. Although the positive and negative polarities are reversed, the tendency of the change in the collector voltage Vc is the same as that of the change in the secondary voltage V2; thus, an effect the same as that of each of Embodiments 1 and 4 can be obtained.

In the foregoing internal-combustion-engine combustion state control apparatus according to Embodiment 5, the high voltage means 202 has a primary coil that generates magnetic flux and accumulates energy when energized, a secondary coil that is magnetically coupled with the primary coil and generates a predetermined high voltage by releasing the accumulated energy, and obtains an ignition-discharge maintaining voltage from the primary voltage of the primary coil. In other words, because the ignition-discharge maintaining voltage is detected by use of the primary voltage of the primary coil 21, i.e., the collector voltage Vc of the transistor 250, there can be outputted a voltage lower than the voltage at the secondary coil 22 that generates a high voltage of several [kV] to several tens [kV]; therefore, on top of the handling easiness because of the circuit configuration, an effect the same as that in each of Embodiments 1 and 4 can be obtained.

The internal-combustion-engine combustion state control apparatus according to any one of Embodiments 1 through 5 of the present disclosure is mounted in an automobile, a motorcycle, an outboard engine, an extra machine, or the like utilizing an internal combustion engine, makes it possible to efficiently operate the internal combustion engine, and can contribute to solving the fuel depletion problem and to preserving the environment.

Although the present application is described above in terms of various exemplary embodiments and implementations, it should be understood that the various features, aspects and functions described in one or more of the individual embodiments are not limited in their applicability to the particular embodiment with which they are described, but instead can be applied, alone or in various combinations to one or more of the embodiments. Therefore, an infinite number of unexemplified variant examples are conceivable within the range of the technology disclosed in the present application. For example, there are included the case where at least one constituent element is modified, added, or omitted and the case where at least one constituent element is extracted and then combined with constituent elements of other embodiments.

What is claimed is:

1. An internal-combustion-engine combustion state control apparatus comprising:
an ignition controller that generates two or more ignition signals during a single compression stroke or a single combustion stroke of an internal combustion engine;
an ignition apparatus including
a high voltage generator that makes an ignition plug, provided in a combustion chamber of the internal combustion engine, generate an ignition discharge based on the ignition signal, and
an ignition-discharge parameter detection circuit that detects a parameter indicating a state of the ignition discharge;
an ignition-discharge duration detector that detects two or more ignition discharge durations, which are respective durations of the two or more ignition discharges generated during a single compression stroke or a single combustion stroke of the internal combustion engine based on an output signal of the ignition-discharge parameter detection circuit;
an abnormal-combustion determiner that diagnoses whether or not abnormal combustion has occurred in the internal combustion engine, based on at least one of the detected two or more ignition discharge durations; and
an abnormal-combustion-suppression controller that controls the internal combustion engine so as to suppress the abnormal combustion, when the abnormal-combustion determiner diagnoses that the abnormal combustion has occurred.

2. The internal-combustion-engine combustion state control apparatus according to claim 1, wherein the abnormal-combustion determiner diagnoses that the abnormal combustion has occurred, when at least one of the two or more ignition discharge durations is the same as or lower than a preliminarily set comparison level.

3. The internal-combustion-engine combustion state control apparatus according to claim 1, wherein the abnormal-combustion determiner diagnoses that the abnormal combustion has occurred, when the ignition discharge duration of the last ignition discharge among the two or more ignition discharges generated during a single compression stroke or a single combustion stroke of the internal combustion engine is the same as or lower than a preliminarily set comparison level.

4. The internal-combustion-engine combustion state control apparatus according to claim 1, wherein when diagnosing that an ignition discharge by the ignition plug is abnormal, the abnormal-combustion determiner prohibits a diagnosis about whether or not the abnormal combustion has occurred.

5. The internal-combustion-engine combustion state control apparatus according to claim 2, wherein when diagnosing that an ignition discharge by the ignition plug is abnormal, the abnormal-combustion determiner prohibits a diagnosis about whether or not the abnormal combustion has occurred.

6. The internal-combustion-engine combustion state control apparatus according to claim 1, wherein when diagnosing that an electric current the same as or higher than a predetermined level leaks from the ignition plug, the abnormal-combustion determiner prohibits a diagnosis about whether or not the abnormal combustion has occurred.

7. The internal-combustion-engine combustion state control apparatus according to claim 2, wherein when diagnosing that an electric current the same as or higher than a predetermined level leaks from the ignition plug, the abnormal-combustion determiner prohibits a diagnosis about whether or not the abnormal combustion has occurred.

8. The internal-combustion-engine combustion state control apparatus according to claim 1, wherein when diagnosing that a misfire of an inflammable fuel-air mixture has occurred in the combustion chamber, the abnormal-combustion determiner prohibits a diagnosis about whether or not the abnormal combustion has occurred.

9. The internal-combustion-engine combustion state control apparatus according to claim 2, wherein when diagnosing that a misfire of an inflammable fuel-air mixture has occurred in the combustion chamber, the abnormal-combustion determiner prohibits a diagnosis about whether or not the abnormal combustion has occurred.

10. The internal-combustion-engine combustion state control apparatus according to claim 1, wherein after a time the same as or longer than an ignition discharge duration, caused by the first ignition signal among the two or more ignition signals, has elapsed, the ignition controller generates an ignition signal following the first ignition signal.

11. The internal-combustion-engine combustion state control apparatus according to claim 2, wherein after a time the same as or longer than an ignition discharge duration, caused by the first ignition signal among the two or more ignition signals, has elapsed, the ignition controller generates an ignition signal following the first ignition signal.

12. The internal-combustion-engine combustion state control apparatus according to claim 2, wherein the comparison level is corrected based on an ignition discharge duration of an ignition signal, belonging to the first half in generation order, among the two or more ignition signals.

13. The internal-combustion-engine combustion state control apparatus according to claim 1, wherein the ignition-discharge parameter detection circuit has an ion current detection circuit that detects an electric quantity based on an ion generated in the combustion chamber, when an inflammable fuel-air mixture in the combustion chamber combusts due to an ignition discharge.

14. The internal-combustion-engine combustion state control apparatus according to claim 2, wherein the ignition-discharge parameter detection circuit has an ion current detection circuit that detects an electric quantity based on an ion generated in the combustion chamber, when an inflammable fuel-air mixture in the combustion chamber combusts due to an ignition discharge.

15. The internal-combustion-engine combustion state control apparatus according to claim 13, wherein the ignition-discharge duration detector masks respective output signals of the ion current detection circuit in the vicinity of an energization-starting timing at which the ignition controller starts application of a primary current of the high voltage generator and in the vicinity of an ignition timing at which the ignition controller cuts off the primary current so as to perform an ignition discharge, and then the ignition-discharge duration detector detects the ignition discharge duration, based on an output signal other than the masked output signals.

16. The internal-combustion-engine combustion state control apparatus according to claim 1, wherein the ignition-discharge parameter detection circuit detects an ignition discharge current in the ignition apparatus or an ignition-discharge maintaining voltage for maintaining the ignition discharge.

17. The internal-combustion-engine combustion state control apparatus according to claim 2, wherein the ignition-discharge parameter detection circuit detects an ignition discharge current in the ignition apparatus or an ignition-discharge maintaining voltage for maintaining the ignition discharge.

18. The internal-combustion-engine combustion state control apparatus according to claim 4, wherein the ignition-discharge parameter detection circuit detects an ignition discharge current in the ignition apparatus or an ignition-discharge maintaining voltage for maintaining the ignition discharge.

19. The internal-combustion-engine combustion state control apparatus according to claim 10, wherein the ignition-discharge parameter detection circuit detects an ignition discharge current in the ignition apparatus or an ignition-discharge maintaining voltage for maintaining the ignition discharge.

20. The internal-combustion-engine combustion state control apparatus according to claim 16, wherein the high voltage generator has a primary coil that generates magnetic flux and accumulates energy when energized, a secondary coil that is magnetically coupled with the primary coil and generates a predetermined high voltage by releasing the accumulated energy, and obtains the ignition-discharge maintaining voltage from the primary voltage of the primary coil.
